(19) United States
(12) Patent Application Publication
(10) Pub. No.: US 2018/0098671 A1
(43) Pub. Date: Apr. 12, 2018

(54) CLEANING IMPLEMENT

(71) Applicant: Jeong Hwa KIM, Jeju-si (KR)

(72) Inventor: Jeong Hwa KIM, Jeju-si (KR)

(21) Appl. No.: 15/474,525

(22) Filed: Mar. 30, 2017

(30) Foreign Application Priority Data
Oct. 7, 2016 (KR) 10-2016-0129900

(51) Int. Cl. A47K 7/02; C11D 3/382; C11D 3/22; C09D 101/02; C09D 199/00; C09D 7/12

(52) U.S. Cl. CPC A47K 7/02; C11D 3/382; C09D 7/1283; C09D 101/02; C09D 199/00; C11D 3/222

(57) ABSTRACT

It is an object of the present invention to provide a cleaning implement which can be used to meet a variety of skin types of users, skin regions and usage, and at the same time, has superior cleaning ability, and can minimize irritation to the skin of the users. To achieve this purpose, the cleaning implement according to the present invention comprises a substrate portion containing konjac as a main component and having a sponge structure; and a coating layer formed by coating on the part of the substrate portion, which is composed of one or more selected from a plurality of natural loofah fragments, a natural cellulose powder, a plurality of natural sponge fragments, hemp fabric and ramie fabric.

### CROSS-REFERENCE TO RELATED APPLICATION

This application claims under 35 U.S.C. § 119(a) the benefit of Korean Patent Application No. 10-2016-0129900 filed on Oct. 7, 2016 the entire contents of which are incorporated herein by reference.

### BACKGROUND

### (a) Technical Field

The present invention relates to a cleaning implement for cleaning the skin, which comprises natural materials.

### (b) Background Art

The cleaning implement includes a loofah for cleaning the dishes and the like, a towel for wiping water or perspiration smeared on the skin of the human body, and a cleansing towel or cleansing sponge for cleaning the skin of the human body.

For the cleaning implement used for cleaning the skin of the human body among the cleaning implements as mentioned above, according to the prior art, a chemical sponge, etc. made of a chemical fiber were used, and thus there was an adverse effect on the skin susceptive to stimulation by causing side effects.

Recently, the use of the natural sponge made of natural materials that can minimize irritation to the skin is increasing. However, since the conventional sponge made of natural materials is composed of only one natural material, it is difficult to use the sponge depending on various skin types or skin regions of the users, and thus, there was a problem that a satisfactory cleaning effect cannot be obtained. That is, in the case of the conventional cleaning implements, it was troublesome to use individual cleaning implements depending on the skin type and the cleaning purpose, and there was a problem that the user must purchase various types of cleaning implements specialized for each skin type or cleaning purpose.

In addition, the conventional sponge made of natural materials has a problem in that when the user repeatedly uses the sponge to a certain extent, the appearance of the sponge is crushed or contracted and thus the user is dissatisfied with the sponge because sufficient foams are not occurred, and the replacement cycle with a new product is short.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art and it is an object of the present invention to provide a cleaning implement which can be used to meet a variety of skin types of users, skin regions and usage and, at the same time, has superior cleaning ability, and can minimize irritation to the skin of the user, in order to solve the above problems.

Another object of the present invention is to provide a cleaning implement wherein the appearance of the cleaning implement is not easily contracted or deformed even after repeated use for a long time.

One aspect of the present invention for achieving the above mentioned object relates to a cleaning implement, and more particularly to a cleaning implement which comprises a substrate portion having a sponge structure and containing konjac as a main component; and a coating layer formed by coating on the part of the substrate portion wherein the coating layer is composed of any one selected from a plurality of natural loofah fragments, a natural cellulose powder, a plurality of natural sponge fragments, hemp fabric and ramie fabric.

Another aspect of the present invention relates to a cleaning implement, and more particularly to a cleaning implement which comprises a substrate portion having a sponge structure and containing konjac as a main component; and a coating layer formed by coating on the part of the substrate portion wherein the coating layer is composed of two or more selected from a plurality of natural loofah fragments, a natural cellulose powder, a plurality of natural sponge fragments, hemp fabric and ramie fabric.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 shows an embodiment of the cleaning implement according to the present invention;

FIG. 2 shows another embodiment of the cleaning implement according to the present invention; and

FIG. 3 is a flow chart of the method of preparing the cleaning implement according to the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, reference will now be made in detail to various embodiments of the present disclosure, examples of which are illustrated in the accompanying drawings and described below.

One aspect of the present invention relates to a cleaning implement, and more particularly, to a cleaning implement which comprises a substrate portion having a sponge structure and containing konjac as a main component; and a coating layer formed by coating on the part of the substrate portion, which is composed of one or any one or two or more selected from a plurality of natural loofah fragments, natural cellulose powder, a plurality of natural sponge fragments, hemp fabric and ramie fabric.

The substrate portion used in the present invention contains konjac as a main component and has a sponge structure. Konjac as mentioned above is made of starch containing glucomannan as a main component, which is obtained from a perennial plant belonging to family taro, a raw material of konjac by planting taro in spring and harvesting in late autumn, and then planting it again in the next spring and harvesting repeatedly for 2-3 years, and thereafter cutting it into thin slices, drying, removing starchy materials. Therefore, the konjac has been mainly used in foods such as soft products such as fish cake, crab meat and the like, ham, frozen foods, and noodles.

On the other hand, konjac has the absorption capacity of water of about 15 to 40 times its own volume. When observing water, konjac is swelled and maintained in the colloidal state, thereby having an excellent water-retentive property and having an excellent moisture-retentive property to prevent surface drying.

Accordingly, the present invention is advantageous, by introducing a substrate portion made of a sponge structure containing konjac component as a main component, in that irritation to the skin when washing the user with sensitive skin is prevented, the massage effect by its unique natural network structure is improved, the effect of removing fine contaminants is enhanced, and also when cleaned the skin, more comfortable washing feeling can be imparted to the skin due to the soft texture of konjac. Particularly, since the substrate portion containing konjac as a main component is composed of dense and fine mesh structure and thus has soft touch, it is suitable for use on the skin region such as the face sensitive and vulnerable to external stimuli.

In the present invention, the shape of the substrate portion is not particularly limited, and for example, various shapes such as rectangular, cube, cylinder, and spherical shape can be used.

In the present invention, the coating layer is formed by coating on the part of the substrate portion. The area on the part of the substrate portion where the coating layer is formed is not limited, but in order to use the cleaning implement of the present invention depending on various skin types of users, skin regions, or usage as intended by the present invention, it is preferable to occupy the area within a half of the surface area of the substrate portion.

In the present invention, it is preferable that the coating layer is composed of any one selected from a plurality of natural loofah fragments, a natural cellulose powder, a plurality of natural sponge fragments, hemp fabric and ramie fabric.

The natural loofah refers to dry spongy tissue part of the fruit of Luffa cylindrica Roemer. Luffa cylindrica Roemer is also referred to sponge-gourd (vegetable sponge) in English. As can be seen from the English name, the natural loofah has a sponge-like property which is attributable to the net-type fiber of the natural loofah. The origin of Luffa cylindrica Roemer is known as tropical Asia and is an annual plant. Luffa cylindrica Roemer is cultivated in Korea, China, Japan, and the like, and natural loofah used in the present invention is not limited to that obtained from Luffa cylindrica Roemer fruit of a certain cultivation region.

The natural loofah is suitable for use in cleaning skin regions less susceptible to external stimuli, such as the body, arms, legs and the like, since the network structure of the natural loofah is not fine or dense compared to the network structure of the substrate portion of the sponge structure containing konjac as a main component, thereby having rough texture relative to the substrate portion of the sponge structure containing konjac as a main component.

In the present invention, since it is preferable that the natural loofah is applied on the substrate portion in the form of plural fragments in order to increase cleaning ability on the skin region which is less sensitive to external stimuli, such as body, arm, leg and the like, the size of the fragments of the natural loofah is not particularly limited, but it is preferable to be 0.001 to 30 mm. The reason is that if the size of the fragments of the natural loofah is less than 0.001 mm, when applied the natural loofah fragments to the substrate portion, the roughness of the surface is not sufficient and there is a problem that the keratin removal effect on the skin is also insignificant, and, on the other hand, if the size of the fragment of the natural loofah is larger than 30 mm, when made into a product, the skin cleansing ability or keratin removal effect is excellent, but the coating layer may be easily peeled off or separated and the service life and quality of the product may be deteriorated.

In the present invention, the natural cellulose is a main component of the cell wall of the higher plants, and is a substance, also referred to as cellulose, having the largest molecular weight among the polysaccharides. Since the molecules of the natural cellulose have a shape in which a large number of glucose are dehydrated and polymerized and connected like a chain, and water molecules can enter between the hydrogen bonds of natural cellulose to achieve new hydrogen bonds, substances made of a natural cellulose can contain a large amount of water, thereby having good absorbency. The natural cellulose has a lowered feeling of smoothness than the sponge containing konjac as a main component and has a feeling of pulpy feel, a tight feeling, thereby being suitable for use in keratin removal of the skin or cleaning of the skin less susceptible to irritation and in cleaning of body, arm, leg, and the like.

In the present invention, it is preferable that the natural cellulose is applied on the substrate portion in the form of powder in order to increase cleaning ability on cleaning face which is less sensitive to external stimuli and the skin region such as body, arm, leg and the like which is less sensitive to external stimuli. Accordingly, the size of the natural cellulose powder is not particularly limited, but it is preferable to be 1 μm to 5000 μm. The reason is that if the size of the natural cellulose powder is less than 1 μm, when applied the natural cellulose powder onto the substrate portion, the roughness of the surface is not sufficient and thus cleaning ability is lowered, and there is a problem that the keratin removal effect on the skin is also insignificant and, on the other hand, if the size of the fragment of the natural cellulose powder is larger than 5000 μm, when made into a product, the coating layer may be easily peeled off or separated and the life and quality of the product is deteriorated.

In the present invention, the natural sponges are called sponges in the English language, and the names are derived from bath sponges. Unlike other sponges, the bathing sponge has no bone fragments and only spongy fibers form the skeleton. Before preparing the sponge artificially, the fibrous tissue of the bathing sponge was processed to make cosmetics, office supplies, machine cleaning products, and bathing wipes and the like. Bathing sponges live in a wide area all over the world including the coast of Korea. Among others, the bathing sponge living in the Mediterranean is the best. In the present invention, the natural sponge means a bathing sponge. Since the natural sponge also has relatively rough texture compared to a sponge containing konjac as a main component, it is suitable for use in keratin removal of the skin or cleaning of the face less susceptible to irritation and in cleaning of body, arm, leg, and the like.

In the present invention, it is preferable that the natural sponge is applied on the substrate portion in the form of plural fragments in order to increase the cleaning ability on cleaning of the face less sensitive to external stimuli and the skin region of body, arm, leg and the like which is less sensitive to external stimuli. Accordingly, the size of the natural sponge is not particularly limited, but it is preferable to be 0.001 to 30 mm. The reason is that if the size of the natural sponge is less than 0.001 mm, when applied the natural sponge to the substrate portion, the roughness of the surface is not sufficient and thus when used on the skin region of body, arm, leg and the like, cleaning ability is lowered, and there is a problem that the keratin removal effect on the skin is also insignificant and, on the other hand, if the size of the fragment of the natural sponge is larger than 30 mm, the skin cleansing ability or keratin removal effect is excellent, but when made into a product, the coating layer may be easily peeled off or separated and the service life and quality of the product may be deteriorated.

In the present invention, the hemp fabric is a cloth woven from hemp, which is woven using bast fibers on the inside of the bark of hemp, absorbs and emits moisture quickly, blocks ultraviolet light, has antimicrobial and anti-toxic properties to inhibit fungi, and has excellent durability. In addition, the ramie fabric is a fabric woven from bast fibers of ramie belonging to the nettle family, which has been widely used as a cloth since ancient times because it is relatively less rough than hemp fabric and has a white color.

In the present invention, since it is preferable that the hemp fabric and ramie fabric are applied on the substrate portion in the form of mesh net shape in order to be used in cleaning the face less sensitive to irritation and to increase the cleaning ability on the skin region, which is less sensitive to external stimuli, such as body, arm, leg and the like, the size of the pores of the hemp fabric and ramie fabric is not particularly limited, but it is preferable to be 0.1 to 30 mm, more preferably, 0.5 to 10 mm, even more preferably 1 to 5 mm. The reason is that if the size of the pores of the hemp fabric and ramie fabric is larger than 30 mm, when applied the hemp fabric and ramie fabric to the substrate portion, the roughness of the surface is not sufficient and thus when used on the skin region of body, arm, leg and the like, the cleaning ability is lowered and there is a problem that the keratin removal effect on the skin is also insignificant, and, on the other hand, if the size of the fragment of the hemp fabric and ramie fabric is smaller than 0.1 mm, the skin cleansing ability or keratin removal effect is excellent, but feeling to the skin is significantly reduced, thereby causing wounds to the skin in use, and thus a problem that the user avoids use may arise.

Further, in the cleaning implement according to an aspect of the present invention, the coating layer preferably has area ratio of the area to be applied per unit area (cm2) of the area to be applied on the substrate portion of at least 5% or more, more preferably 20 to 90%, even more preferably 50 to 90%. The reason is that if the area ratio of the area to be applied per unit area (cm²) of the area to be applied on the substrate portion is less than 5%, the area ratio occupied by the coating layer is excessively small and the applying effect of the coating layer is insignificant and therefore when used on the skin region of body, arm, leg and the like, there is a problem that cleaning ability is lowered.

On the other hand, in the cleaning implement according to the present invention, since the coating layer composed of one or any one or two or more selected from a plurality of natural loofah fragments, a natural cellulose powder, a plurality of natural sponge fragments, hemp fabric and ramie fabric is tightly coupled to the part of the substrate portion containing konjac as a main component, as described above, and therefore the coating layer serves to fix the fibers in the contact portion of the substrate portion, the appearance of the product is maintained, as it is without contraction or deformation even after repeated use for a long time and therefore the replacement cycle of the product is much longer than that of the conventional natural material cleaning implement.

Another aspect of the present invention relates to a cleaning implement, and more particularly to a cleaning implement which comprising a substrate portion having a sponge structure and containing konjac as a main component; and a coating layer formed by coating on the part of the substrate portion, which is composed of two or more selected from a plurality of natural loofah fragments, a natural cellulose powder, a plurality of natural sponge fragments, hemp fabric and ramie fabric.

In another embodiment of the present invention, the coating layer is characterized by formed by two or more kinds of coating materials. For example, the coating layer may be composed of two kinds of a plurality of natural loofah fragments—natural cellulose powder, a plurality of natural loofah fragments—a plurality of natural sponge fragments, and natural cellulose powder—a plurality of natural sponge fragments, etc., or three kinds of a plurality of natural loofah fragments—a natural cellulose powder—a plurality of natural sponge fragments, a plurality of natural loofah fragments—natural cellulose powder—hemp fabric, a plurality of natural loofah fragments—natural cellulose powder—ramie fabric, and also may be composed of the more kinds. The mixing ratio of two or more kinds of coating materials to be mixed in the coating layer is not particularly limited and the mixing ratio can be arbitrarily set at the time of production.

In another aspect of the present invention, although the coating area ratio of the coating layer is not particularly limited, it is preferable that the area ratio of the area coated by the coating layer per unit area (cm2) of the surface to be coated on the substrate portion is at least 5%, more preferably 20 to 90%, even more preferably 50 to 90%. The reason is that if the area ratio of the area coated by the coating layer per unit area (cm2) of the surface to be coated on the substrate portion is less than 5%, the area ratio occupied by the coating layer is excessively small and the applying effect of the coating layer composed of at least two kinds of coating materials is insignificant and therefore when used on the skin region of body, arm, leg and the like, there is a problem that cleaning ability is lowered.

In another embodiment of the present invention, since the coating layer is composed of two or more selected from a plurality of natural loofah fragments, natural cellulose powder, a plurality of natural sponge fragments, hemp fabric and ramie fabric, and therefore surface roughness or unevenness of the coating layer is irregular compared to the coating layer made of one kind of coating material, not only cleaning ability of the coating layer is further improved as compared with the coating layer composed of one kind of coating material, but also there is an advantage that the appearance of the product is kept longer because the coating layer more firmly fixes the fibers in the contact portion of the substrate portion, and additionally when applied to the skin during the shower, there is an advantage of having skin acupressure and skin massage effect.

Hereinafter, the present invention will be described with reference to the accompanying drawings. The following drawings and the descriptions relating to the drawings is only an example for explaining the present invention, and thus the scope of the present invention is not limited thereto.

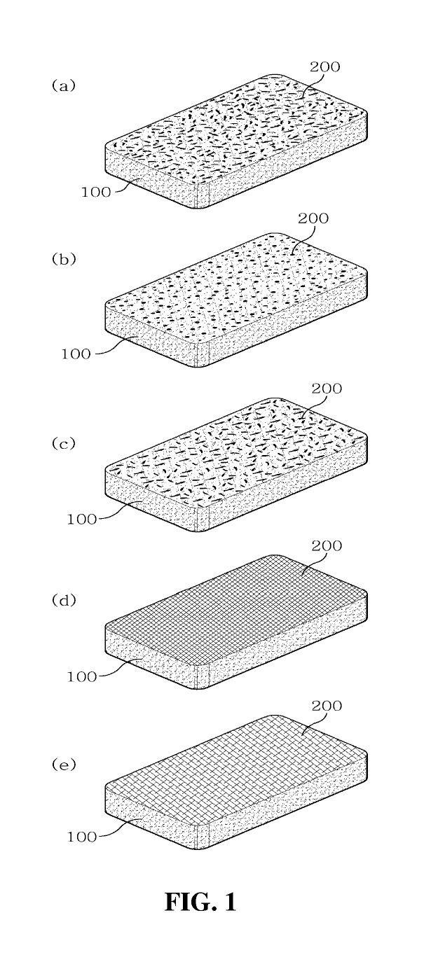

FIG. 1 shows an example of a cleaning implement according to the present invention. The cleaning implement of the present invention shown in FIG. 1(a) is composed of a substrate portion 100 containing konjac as a main component and having a sponge structure and a coating layer 200 formed by coating a plurality of natural loofah fragments to one surface of the substrate portion 100.

In addition, the cleaning implement of the present invention shown in FIG. 1(b) is composed of a substrate portion 100 containing konjac as a main component and having a sponge structure and a coating layer 200 formed by coating a natural cellulose powder to one surface of the substrate portion 100.

In addition, the cleaning implement of the present invention shown in FIG. 1(c) is composed of a substrate portion 100 containing konjac as a main component and having a sponge structure and a coating layer 200 formed by coating a plurality of natural sponge fragments to one surface of the substrate portion 100.

In addition, the cleaning implement of the present invention shown in FIG. 1(d) is composed of a substrate portion 100 containing konjac as a main component and having a sponge structure and a coating layer 200 formed by coating hemp fabric to one surface of the substrate portion 100.

In addition, the cleaning implement of the present invention shown in FIG. 1(e) is composed of a substrate portion 100 containing konjac as a main component and having a sponge structure and a coating layer 200 formed by coating ramie fabric to one surface of the substrate portion 100.

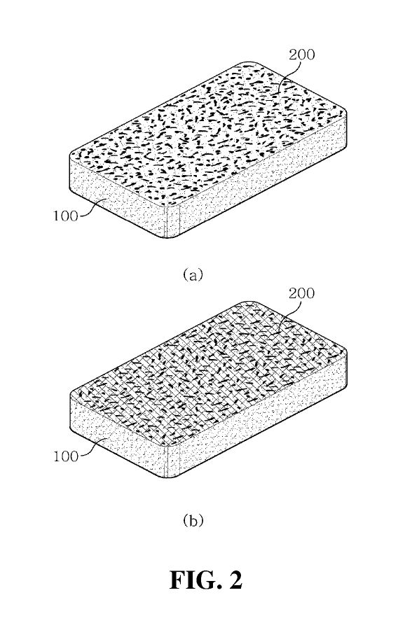

FIG. 2 shows another example of the cleaning implement according to the present invention. The cleaning implement of the present invention shown in FIG. 2(a) is composed of a substrate portion 100 containing konjac as a main component and having a sponge structure and a coating layer 200 formed by coating a plurality of natural loofah fragments and the natural cellulose powder to one surface of the substrate portion 100.

In addition, the cleaning implement of the present invention shown in FIG. 2(b) is composed of a substrate portion 100 containing konjac as a main component and having a sponge structure and a coating layer 200 formed by coating a plurality of natural loofah fragments and ramie fabric to one surface of the substrate portion 100.

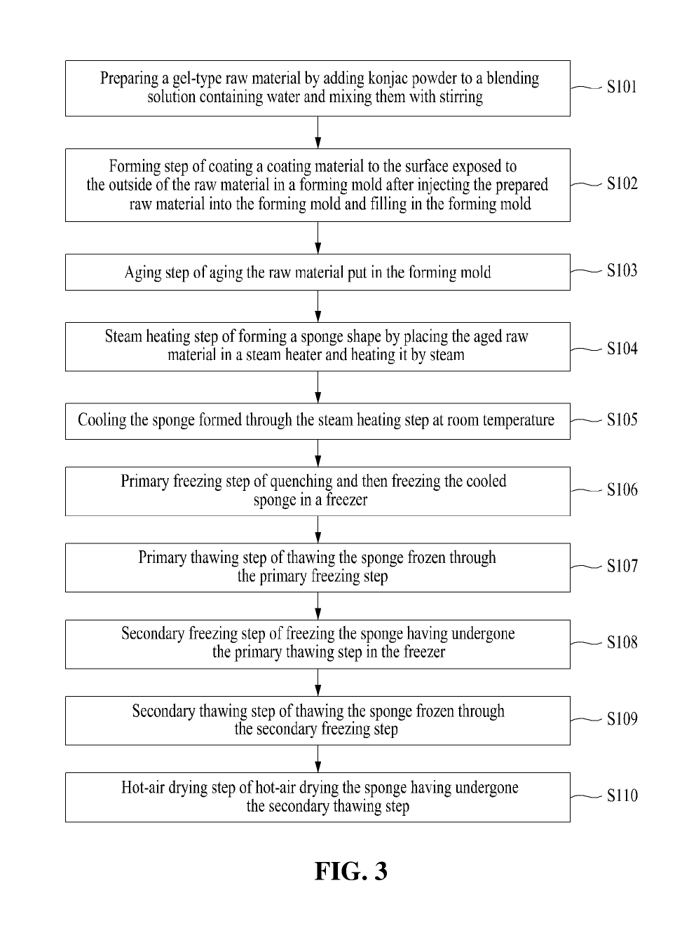

FIG. 3 is a flowchart showing a method of preparing the cleaning implement according to the present invention. Referring to FIG. 2, the method of preparing the cleaning implement according to the present invention will be described as follows.

Referring to FIG. 3, a method of preparing the cleaning implement according to the present invention comprises a step (S101) of preparing a gel-type raw material by adding konjac powder to a blending solution containing water and mixing them with stirring; a forming step (S102) of coating a coating material to the surface exposed to the outside of the raw material in a forming mold after injecting the prepared raw material into the forming mold and filling in the forming mold; an aging step (S103) of aging the raw material put in the forming mold; a steam heating step (S104) of forming a sponge shape by placing the aged raw material in a steam heater and heating it by steam; a step (S105) of cooling the sponge formed through the steam heating step at room temperature; a primary freezing step (S106) of quenching and then freezing the cooled sponge in a freezer; a primary thawing step (S107) of thawing the sponge frozen through the primary freezing step; a secondary freezing step (S108) of freezing the sponge having undergone the primary thawing step in the freezer; a secondary thawing step (S109) of thawing the sponge frozen through the secondary freezing step; and a hot-air drying step (S110) of hot-air drying the sponge having undergone the secondary thawing step.

Each step of the preparing method of the cleaning implement according to the present invention will be described in more detail as follows.

\textcircled{1} Step (S101) of Preparing a Raw Material

In the step (S101) of preparing the raw material, the blending solution is a blending solution usually used for sponge production, and is formed by mixing water, a neutralizing agent, a foaming agent, an emulsifying agent, and the like.

In the step (S101) of preparing the raw material, the content of the konjac powder added to the blend solution is preferably 1 part by weight of the konjac powder relative to 12 parts by weight of the blending solution. The mixing ratio as mentioned above is such that when the sponge is formed, the konjac powder is sufficiently dissolved in the blending solution, and then the sponge shape can be smoothly formed by the blending solution. In this case, the konjac powder is dissolved and gelated (S101).

Accordingly, when the above-described blending solution and konjac powder are mixed and stirred with a stirrer, the bubbles are formed through the steam heating step to be described later, and the shape of the sponge can be achieved.

\textcircled{2} Forming Step (S102)

In the forming step (S102), the raw material produced through the step (S101) of preparing the raw material is poured into a forming mold to form a desired shape.

At this time, the raw material in the form of gel prepared through the step (S101) of preparing the raw material is filled in a forming mold, and then any one or two or more selected from a plurality of natural loofah fragments, a natural cellulose powder, a plurality of natural sponge fragments, hemp fabric and ramie fabric is coated to the surface exposed to the outside of the raw material in the forming mold, and the coated material is adhered to the surface of the raw material by the viscosity of the gel-type raw material.

The method of coating a plurality of natural loofah fragments, a natural cellulose powder, and a plurality of natural sponge fragments in the above-mentioned coating materials is not particularly limited, but it is preferable to coat by placing a predetermined amount of the above-mentioned coating materials on a porous plate (tray) and using vibration. It is preferable that the coating material is coated at the area ratio of at least 5% or more per unit area (cm2) of the surface to be coated of the raw material which is the substrate portion when commercialized, more preferably 20 to 90%, even more preferably 50 to 90%.

In addition, it is preferable that the hemp fabric and ramie fabric are a porous fabric and is cut to meet the shape of the forming mold and then applied. The average size of the pores of the hemp fabric and ramie fabric is not particularly limited, but is preferably 0.1 to 30 mm, more preferably 0.5 to 10 mm, even more preferably 1 to 5 mm. The reason is that if the average size of the pores of the hemp fabric and ramie fabric is greater than 30 mm, when applied the hemp fabric and ramie fabric to the substrate portion, the roughness of the surface is not sufficient and thus when used on the skin region of body, arm, leg and the like, the cleaning ability is lowered and there is a problem that the keratin removal effect on the skin is also insignificant, and on the other hand, if the average size of the pores of the hemp fabric and ramie fabric is smaller than 0.1 mm, the skin cleaning ability or keratin removal effect is excellent, but feeling to the skin is significantly reduced thereby causing wounds to the skin in use and thus a problem that the user avoids use may arise.

In addition, when the coating material comprises two or more selected from a plurality of natural loofah fragments, a natural cellulose powder, a plurality of natural sponge fragments, hemp fabric and ramie fabric, it is possible to coat by applying various kinds of coating materials sequentially to the surface exposed to the outside of the raw material in the forming mold, and in particularly, when the coating material comprises two or more selected from a plurality of natural loofah fragments, a natural cellulose powder, and a plurality of natural sponge fragments, it is preferable that in order to improve the convenience and efficiency of work, various kinds of coating materials are firstly mixed to form a mixed coating material and then the mixed coating material is coated to the surface exposed to the outside of the raw material in the forming mold.

\textcircled{3} Aging Step (S103)

The Aging step (S103) is for aging the gel-type raw material contained in the forming mold so that the raw material is completely expanded and solidified according to the shape of the forming mold.

\textcircled{4} Steam Heating Step (S104)

The steam heating step (S104) is a procedure of forming a sponge shape by forming bubbles in the raw material through steam heating of the aged raw material after the aging step (S103). At this time, the coating material coated on the raw material is combined with the fibers of the coating material during the steam heating process due to the intrinsic viscosity of the konjac component of the sponge, thereby forming a coated layer bonded on a raw material (substrate portion) containing konjac as a main component without using adhesives that could have a detrimental effect on the human body.

\textcircled{5} Cooling Step (S105)

The cooling step (S105) relates to a step of slowly cooling the sponge formed through the steam heating step (S104) at room temperature before quenching

\textcircled{6} Primary Freezing Step (S106)

The primary freezing step (S106) is a step of quenching the sponge after the cooling step (S105) to subzero temperature and then freezing it in the freezer. This is to make the glucomannan natural fiber, which is the main component of konjac contained in the sponge, and the applied coating materials to be firmly adhered to each other, by quickly freezing the surface of the sponge.

\textcircled{7} Primary Thawing Step (S107)

This step is a step of thawing the frozen sponge through the primary freezing step (S106) and removing residual additives from the blending solution contained in the sponge, which is performed before the secondary freezing step, i.e., the next step.

\textcircled{8} Secondary Freezing Step (S108)

This step is a step of freezing the sponge, which has undergone the primary thawing step (S107), to subzero temperature in the freezer. By repeating the freezing process in this way, the natural fiber of the sponge containing konjac as a main component and the applied coating material can be more firmly adhered to each other, thereby prolonging the service life of the sponge product

\textcircled{9} Secondary Thawing Step (S109)

This step is a step of thawing frozen sponge through the secondary freezing step (S108) and completely removing the additives and impurities from the blending solution remaining in the sponge, which is performed before the hot-air drying step, i.e., the next step.

\textcircled{10} Hot-Air Drying Step (S110)

The hot-air drying step (S110) is a step of hot-air drying the sponge having undergone the second defrosting step (S109) for storage for a long period of time. This process is carried out in order to prevent fungi and bacteria from propagating because the manufactured sponge contains the konjac components and the coating components (natural loofah fragments, natural cellulose powder, natural sponge fragments, hemp fabric and ramie fabric) which are a natural material and in the state of containing water, fungi and bacteria can grow.

Hereinafter, in order to facilitate understanding of the cleaning implement according to the present invention, examples will be described. The following examples are only illustrative of the present invention, and the scope of the present invention is not limited thereby.

### EXAMPLES

1. Preparation of Cleaning Implement

### Example 1

### Preparation of the Cleaning Implement Having Area Ratio of the Area Coated by the Coating Layer per Unit Area (cm2) of the Surface to be Coated on the Substrate Portion of 1%

The konjac powder was added to the blending solution containing water (the content of the konjac powder added to the blending solution is 1 part by weight of konjac powder relative to 12 parts by weight of the blending solution), and the mixture was stirred to prepare a gel-type raw material, and then the prepared raw material was injected into a forming mold and filled, and then a plurality of natural sponge fragments as a coating material were applied to the surface exposed to the outside of the raw material in the forming mold at a coating ratio of 1% per unit area (cm2).

The raw materials put into the forming mold were aged, and the aged raw materials were placed in a steam heater and heated by steam to form a sponge shape, followed by cooling at room temperature.

The cooled sponge was quenched in a freezer and then was primarily frozen and the frozen sponge through the primary freezing step was primarily thawed.

Next, the sponge having undergone the primary thawing step was secondarily frozen in the freezer, and the secondarily frozen sponge was secondly thawed, and dried by hot-air to prepare a cleaning implement.

### Example 2

### Preparation of the Cleaning Implement Having Area Ratio of the Area Coated by the Coating Layer per Unit Area (cm2) of the Surface to be Coated on the Substrate Portion of 3%

The cleaning implement was prepared in the same manner as in Example 1 above, except that the area ratio of the area coated by the coating layer per unit area (cm2) of the surface to be coated on the substrate portion is 3%.

### Example 3

### Preparation of the Cleaning Implement Having Area Ratio of the Area Coated by the Coating Layer per Unit Area (cm2) of the Surface to be Coated on the Substrate Portion of 5%

The cleaning implement was prepared in the same manner as in Example 1 above, except that the area ratio of the area coated by the coating layer per unit area (cm2) of the surface to be coated on the substrate portion is 5%.

### Example 4

### Preparation of the Cleaning Implement Having Area Ratio of the Area Coated by the Coating Layer per Unit Area (cm2) of the Surface to be Coated on the Substrate Portion of 10%

The cleaning implement was prepared in the same manner as in Example 1 above, except that the area ratio of the area coated by the coating layer per unit area (cm2) of the surface to be coated on the substrate portion is 10%.

### Example 5

### Preparation of the Cleaning Implement Having Area Ratio of the Area Coated by the Coating Layer per Unit Area (cm2) of the Surface to be Coated on the Substrate Portion of 20%

The cleaning implement was prepared in the same manner as in Example 1 above, except that the area ratio of the area coated by the coating layer per unit area (cm2) of the surface to be coated on the substrate portion is 20%.

### Example 6

### Preparation of the Cleaning Implement Having Area Ratio of the Area Coated by the Coating Layer per Unit Area (cm2) of the Surface to be Coated on the Substrate Portion of 50%

The cleaning implement was prepared in the same manner as in Example 1 above, except that the area ratio of the area coated by the coating layer per unit area (cm2) of the surface to be coated on the substrate portion is 50%.

### Example 7

### Preparation of the Cleaning Implement Having Area Ratio of the Area Coated by the Coating Layer per Unit Area (cm2) of the Surface to be Coated on the Substrate Portion of 70%

The cleaning implement was prepared in the same manner as in Example 1 above, except that the area ratio of the area coated by the coating layer per unit area (cm2) of the surface to be coated on the substrate portion is 70%.

### Example 8

### Preparation of the Cleaning Implement Having Area Ratio of the Area Coated by the Coating Layer per Unit Area (cm2) of the Surface to be Coated on the Substrate Portion of 80%

The cleaning implement was prepared in the same manner as in Example 1 above, except that the area ratio of the area coated by the coating layer per unit area (cm2) of the surface to be coated on the substrate portion is 90%.

### Example 9

### Preparation of the Cleaning Implement Having Average Size of the Pores of the Coating Layer of 0.05 mm

The konjac powder was added to the blending solution containing water (the content of the konjac powder added to the blending solution is 1 part by weight of the konjac powder relative to 12 parts by weight of the blending solution), and the mixture was stirred to prepare a gel-type raw material, and then the prepared raw material was injected into a forming mold and filled, and then hemp fabric was applied to the surface exposed to the outside of the raw material in the forming mold. At this time, the hemp fabric having the average size of the pores of 0.05 mm was used.

The raw materials put into the forming mold were aged, and the aged raw materials were placed in a steam heater and heated by steam to form a sponge shape, followed by cooling at room temperature.

The cooled sponge was quenched in a freezer and then was primarily frozen and the frozen sponge through the primary freezing step was primarily thawed.

Next, the sponge having undergone the primary thawing step was secondarily frozen in the freezer, and the secondarily frozen sponge was secondly thawed, and dried by hot-air to prepare a cleaning implement.

### Example 10

### Preparation of the Cleaning Implement Having Average Size of the Pores of the Coating Layer of 0.1 mm

The cleaning implement was prepared in the same manner as in Example 9 above, except that the average size of the pores of the hemp fabric, i.e., a coating material is 0.1 mm.

### Example 11

### Preparation of the Cleaning Implement Having Average Size of the Pores of the Coating Layer of 0.5 mm

The cleaning implement was prepared in the same manner as in Example 9 above, except that the average size of the pores of the hemp fabric, i.e., a coating material is 0.5 mm.

### Example 12

### Preparation of the Cleaning Implement Having Average Size of the Pores of the Coating Layer of 1 mm

The cleaning implement was prepared in the same manner as in Example 9 above, except that the average size of the pores of the hemp fabric, i.e., a coating material is 1 mm.

### Example 13

### Preparation of the Cleaning Implement Having Average Size of the Pores of the Coating Layer of 5 mm

The cleaning implement was prepared in the same manner as in Example 9 above, except that the average size of the pores of the hemp fabric, i.e., a coating material is 5 mm.

### Example 14

### Preparation of the Cleaning Implement Having Average Size of the Pores of the Coating Layer of 10 mm

The cleaning implement was prepared in the same manner as in Example 9 above, except that the average size of the pores of the hemp fabric, i.e., a coating material is 10 mm.

2. Evaluation of the Cleaning Ability and Skin Touch of the Cleaning Implement

Each of 30 male and female adults was allowed to use 14 types of cleaning implements of Examples 1 to 14 on the skin of the arms, legs, and body portions to evaluate the cleaning ability and the satisfaction of skin touch (very satisfied: 5 points, satisfaction: 4 points, general: 3 points, dissatisfied: 2 points, very unsatisfied: 1 point), and the results are shown in Tables 1 and 2 below.

TABLE 1

| | Area ratio of the | Average | Average |
|---|---|---|---|
| | area coated by the coating | score of cleaning | score of skin |
| | layer per unit area (cm2) | ability | feeling |
| Example 1 | 1% | 1.43 | 4.01 |
| Example 2 | 3% | 2.1 | 4.0 |
| Example 3 | 5% | 3.14 | 3.95 |
| Example 4 | 10% | 3.7 | 3.82 |
| Example 5 | 20% | 4.09 | 3.83 |
| Example 6 | 50% | 4.21 | 3.69 |
| Example 7 | 70% | 4.29 | 3.69 |
| Example 8 | 90% | 4.18 | 3.60 |

As shown in Table 1, in the case of Examples 1 and 2, it was confirmed that the degree of satisfaction of the skin touch of the coating layer is relatively high but the satisfaction of the cleansing ability is excessively low. In the case of remaining Examples 3 to 8, i.e., for the cleaning implement having the area ratio of the area coated by the coating layer per unit area (cm2) of 5% or more, in general, the degree of satisfaction of the cleansing ability on the coating layer is relatively high, while the degree of satisfaction of the skin touch is also not bad

TABLE 2

| | Average size of | Average | Average |
|---|---|---|---|
| | the pores of the coating | score of cleaning | score of skin |
| | layer | ability | feeling |
| Example 9 | 0.05 mm | 4.4 | 1.35 |
| Example | 0.1 mm | 4.38 | 3.03 |
| 10 | | | |
| Example | 0.5 mm | 4.23 | 3.63 |
| 11 | | | |
| Example | 1.0 mm | 4.15 | 4.14 |
| 12 | | | |
| Example | 5.0 mm | 4.01 | 4.23 |
| 13 | | | |
| Example | 10.0 mm | 3.73 | 4.26 |
| 14 | | | |

As shown in Table 2, in the case of Example 9, it was confirmed that the degree of satisfaction of the cleaning ability of the coating layer was relatively high, but the degree of satisfaction of the skin touch of the coating layer was somewhat low. In the case of remaining Examples 10 to 14, it can be seen that the degree of satisfaction of the cleansing ability of the coating layer is generally high, while the degree of satisfaction for the skin touch might be also not bad.

As described above, those skilled in the art will understand that the present invention may be implemented in other specific forms without departing from the spirit or essential characteristics thereof. It will be understood by those skilled in the art that the scope of the claims is defined by the appended claims rather than by the description and all changes or modifications derived from the meaning and scope of the claims and their equivalents are within the scope of the present invention.

According to the cleaning implement of the present invention, the substrate portion containing konjac as a main component and the coating layer, which is composed of any one or two or more selected from a plurality of natural loofah fragments, a natural cellulose powder, a plurality of natural sponge fragments, hemp fabric and ramie fabric, on the part of the substrate portion are tightly coupled to each other to integrate natural materials of different qualities into one cleaning implement. Therefore, the user can select and use any suitable natural material sites depending on the skin type or skin region, thereby increasing the cleaning ability, there is an effect that may select and use suitable natural materials depending on cleaning purpose such as face cleansing and bath, etc. even while using one cleaning implement, and thus the user can reduce the price burden because the user does not have to separately purchase sponge products for various purposes, and the convenience of the maintenance of the cleaning implement is increased

In addition, since the cleaning implement according to the present invention is composed of natural materials and thus irritation to the user's skin can be minimized, there is an effect that may prevent side effects to the skin, which may occur when using a product made of conventional chemical fibers.

The cleaning implement according to the present invention has an advantage that the substrate portion containing konjac as a main component is tightly coupled to a coating layer on the part of the substrate portion, which is composed of any one or two or more selected from a plurality of natural loofah fragments, a natural cellulose powder, a plurality of natural sponge fragments, hemp fabric and ramie fabric, and therefore the appearance of the cleaning implement is not contracted or deformed even after repeated use for a long time and is maintained, as it is, and the replacement cycle of the product is longer than that of the conventional natural material cleaning implement.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A cleaning implement comprising a substrate portion containing konjac as a main component and having a sponge structure; and a coating layer formed by coating a coating material on the part of the substrate portion, which is composed of one or more selected from a plurality of natural loofah fragments, a natural cellulose powder, a plurality of natural sponge fragments, hemp fabric and ramie fabric,
wherein the coating layer has area ratio of the area coated by the coating layer per unit area (cm2) of the surface to be coated on the substrate portion of 50 to 90%, and
wherein the coating layer is formed by coating a coating material on the surface exposed to the outside of a raw material in the molding mold, in the state that the gel-type raw material formed by adding konjac powder to a blending solution containing water, and mixing them with stirring is injected into and filled in a forming mold.

2. The cleaning implement according to claim 1 characterized in that the size of the natural loofah fragments is 0.001 to 30 mm.

3. The cleaning implement according to claim 1 characterized in that the particle size of the natural cellulose powder is 1 μm to 5000 μm.

4. The cleaning implement according to claim 1 characterized in that the size of the natural sponge fragments is 0.001 to 30 mm.

5. The cleaning implement according to claim 1 characterized in that the average size of pores of the hemp fabric and ramie fabric is 0.1 to 30 mm.
